(19) United States
(12) Patent Application Publication
(10) Pub. No.: US 2010/0260211 A1
(43) Pub. Date: Oct. 14, 2010

(54) All-fiber staturable absorber Q-switched laser and method for producing staturable absorber Q-switched pulse

(75) Inventor: Tzong-Yow Tsai, Tainan City (TW)

Correspondence Address: BACON & THOMAS, PLLC, 625 SLATERS LANE, FOURTH FLOOR, ALEXANDRIA, VA, 22314-1176, US

(73) Assignee: National Cheng Kung University, Tainan City (TW)

(21) Appl. No.: 12/656,432

(22) Filed: Jan. 29, 2010

(30) Foreign Application Priority Data
Apr. 14, 2009 (TW) 98112271

(51) Int. Cl. H01S 3/30; H01S 3/113

(52) U.S. Cl. 372/6; 372/11

(57) ABSTRACT

An all-fiber saturable absorber Q-switched laser and the method for producing saturable absorber Q-switched pulses are provided. By locating a saturable absorber fiber in the intensity-enhanced section of a ring resonator, the Q-switched pulses are produced and enhanced. The present application is advantageous in the simple design and effective cost, and is applicable for a variety of fiber-type laser materials.

### BACKGROUND

1. Field of the Invention

The present invention relates generally to a Q-switched laser, and more particularly, to a passively Q-switched laser.

2. Background of the Invention

Q-switched operation is a useful technique employed in laser systems to produce short and high-intensity laser pulses. Q-switched lasers can be realized using active or passive Q-switches. The passive Q-switched laser is also called the saturable absorber Q-switched laser because of using a saturable absorber material in the resonator to modulate the Q factor and produce laser pulses. Compared to the active Q-switched laser, the passive Q-switched laser has the advantages of high efficiency, flexibility, compactness and low cost. The saturable absorber medium, however, is hard to acquire.

The traditional Q-switched fiber lasers generally employ bulk Q-switches. These fiber lasers contain free-space sections in the resonators, and require sophisticated techniques of alignment for in-and-out light coupling between fibers and the Q-switches. The disadvantages of these fiber lasers are high cavity loss, low Q-switching efficiency and difficulties of packaging.

All-fiber actively Q-switched lasers have been realized using active Q-switches as acousto-optic modulators, piezoelectric (PZT) actuators and magnetostrictive transducers. These active Q-switches require additional electronically driven apparatuses that increase the cost of laser systems.

To solve the problems above, applicants previously presented an idea of an all-fiber passive Q-switched laser (TW patent application No. 96144909). The idea is that the photon density passing through a saturable absorber fiber is increased by adjusting the area ratio of the cores between the saturable absorber fiber and the gain fiber. The enhanced power density in the saturable absorber fiber results in a fast saturation rate of absorption population and then activated the Q-switching mechanism. To improve the Q-switching efficiency and simplify the laser scheme, applicants provide the present invention of All-Fiber Saturable Absorber Q-switched Laser and Method for Producing Saturable Absorber Q-switched Pulse.

### SUMMARY

The present invention provides an all-fiber saturable absorber Q-switched laser which is simple and suitable for various laser materials.

The present invention also provides an all-fiber saturable absorber Q-switched laser which is composed of fiber-type components and capable of producing high-intensity laser pulses after being pumped.

According to one aspect of the present invention, the all-fiber saturable absorber Q-switched laser of the present invention includes a gain fiber, an optical circulator, a fiber grating, and a saturable absorber fiber. The gain fiber is pumped by a pump source and then emits a laser beam. The optical circulator is configured at an output side of the gain fiber to exclude a light beam emitted by the pump source and to output the laser beam. The fiber grating is configured at a first output side of the optical circulator to reflect the laser beam; and the fiber grating and the optical circulator define an intensity-enhanced section. The saturable absorber fiber is configured in the intensity-enhanced section to absorb the laser beam and to produce a laser pulse when the saturable absorber fiber is saturated.

Preferably, the gain fiber, the optical circulator and the fiber grating form a ring resonator.

Preferably, the fiber grating is configured to reflect a part of the laser beam back to the ring resonator and to output a remaining part of the laser beam which is not reflected thereby.

Preferably, the all-fiber saturable absorber Q-switched laser further includes a power splitter configured at a second output side of the optical circulator to output a certain part of laser beam from the ring resonator.

Preferably, the optical circulator is configured to control the resonant direction of the ring resonator.

Preferably, the wavelength of the saturable absorber Q-switched laser is determined by the reflected spectrum of the fiber grating.

Preferably, the all-fiber saturable absorber Q-switched laser further includes a wavelength-division multiplexer configured at an input side of the gain fiber to couple the light beam emitted by the pump source into the gain fiber.

Preferably, the gain fiber is an erbium-doped fiber.

Preferably, the saturable absorber fiber is an erbium-doped fiber.

According to another aspect of the present invention, a method for producing a saturable absorber Q-switched laser pulse is provided. The method includes steps of pumping a gain fiber by a pump source to emit a laser beam; guiding the laser beam to an optical circulator to control the resonant direction of the laser beam; and absorbing the laser beam by a saturable absorber fiber and producing a laser pulse after the saturable absorber fiber is saturated

Preferably, the method further includes a step of coupling the light beam emitted by the pump source into the gain fiber by a wavelength division multiplexer to pump the gain fiber and generate the laser beam.

Preferably, the method further includes a step of determining the wavelength of the saturable absorber Q-switched laser and reflecting a part of the laser beam back to the ring resonator.

Preferably, the method further includes a step of outputting a certain part of the laser beam from the ring resonator.

Preferably, the saturable absorber fiber absorbs the laser beam until the saturable absorber fiber is saturated.

### BRIEF DESCRIPTION OF THE DRAWINGS

The foregoing aspects described herein will become more readily apparent by reference to the following Description when taken in conjunction with the accompanying drawings wherein:

FIG. 1 is a schematic diagram of an all-fiber saturable absorber Q-switched laser according to the first embodiment;

FIG. 2 is the output measurement of the all-fiber saturable absorber Q-switched laser with accordance to the first embodiment; and

FIG. 3 is a schematic diagram of the all-fiber saturable absorber Q-switched laser according to the second embodiment.

### DESCRIPTION OF THE PREFERRED EMBODIMENT

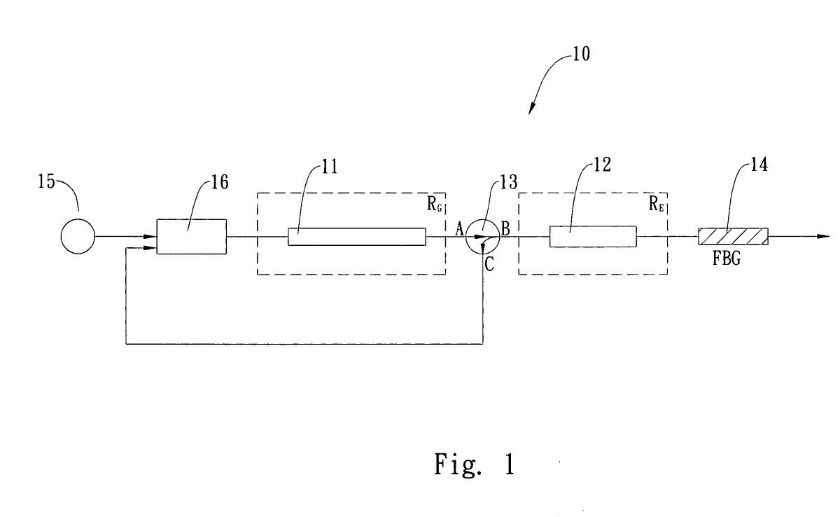

FIG. 1 is a schematic diagram of an all-fiber saturable absorber Q-switched laser 10 according to the first embodiment. The all-fiber saturable absorber Q-switched laser 10 and method for producing saturable absorber Q-switched laser are understood with reference to FIG. 1. According to this embodiment, the all-fiber saturable absorber Q-switched laser 10 with a ring resonator of the present invention includes a gain fiber 11, a saturable absorber fiber 12, an optical circulator 13, a fiber grating 14 and other optical components. The ring resonator is formed by the gain fiber 11, the optical circulator 13, and the fiber grating 14.

The gain fiber 11 configured in a gain region R_{G} of the all-fiber saturable absorber Q-switched laser 10 is excited by a pump source15 and emits a laser beam to the optical circulator 13.

The optical circulator 13 is configured at an output side of the gain fiber to receive the laser beam emitted from the gain fiber 11 and to determine the paths of the laser beam from point A to point B and point B to point C in the optical circulator 13. The optical circulator 13 is also configured to exclude a light beam emitted by the pump source15, thereby preventing the saturable absorber fiber 12 from absorbing the light beam emitted by the pump source15 since the light beam may pass through the gain fiber 12.

The fiber grating 14 is configured at a first output side (port B) of the optical circulator 13. Moreover, the fiber grating 14 and the optical circulator 13 define an intensity-enhanced section R_{E}. A certain part of the laser beam passing through the optical circulator 13 (from port A to port B) is reflected back into the ring resonator (from port B to port C) by the fiber grating 14. The laser beam that is not reflected by the fiber grating 14 is outputted. The wavelength of the laser beam is decided by the reflection spectrum of the fiber grating 14.

The saturable absorber fiber 12 is configured in the intensity-enhanced section R_{E} of the all-fiber saturable absorber Q-switched laser 10 to absorb the laser beam (from port A to port B) and to produce a laser pulse when the saturable absorber fiber is saturated.

The all-fiber saturable absorber Q-switched laser 10 of the present invention further comprises a wavelength division multiplexer (WDM) 16 which is configured at an output side of the pump source15 or an input side of the gain fiber 12 to couple the light beam emitted by the pump source15 into the gain fiber 11, combined with the reflected part of the laser beam. The laser beam is absorbed twice when double passing through the saturable absorber fiber 12. When the saturable absorber fiber 12 is saturated, the laser beam is not absorbed by the saturable absorber fiber 12, thus giving rise to the laser pulse.

It is understood that the laser beam passes through the intensity-enhanced section R_{E} twice in one roundtrip of the all-fiber saturable absorber Q-switched laser 10 of the present invention. The photon density in the saturable absorber fiber 12 is therefore on average twice (or more than twice) that in the gain fiber 11. The higher photon intensity results in a fast bleaching of the saturable absorber fiber 12, and then a passive Q-switching performance.

In one preferred embodiment of the present invention, the gain fiber 11 and the saturable absorber fiber 12 are erbium-doped fibers.

The material of the gain fiber 11 and the saturable absorber fiber 12 may be the same in the present invention. The gain fiber 11 and the saturable absorber fiber 12, in one preferred embodiment of the present invention, are the same erbium-doped fibers having an absorption loss of 110 dB/m at 1530 nm, and a core diameter of 4 μm as example. The length of the gain fiber 11 is 50 cm and that of the saturable absorber fiber 12 is 15 cm. The reflectivity of the fiber grating 14 is 10% with a bandwidth less than 0.2 nm. The total roundtrip length of the ring resonator is 400 cm.

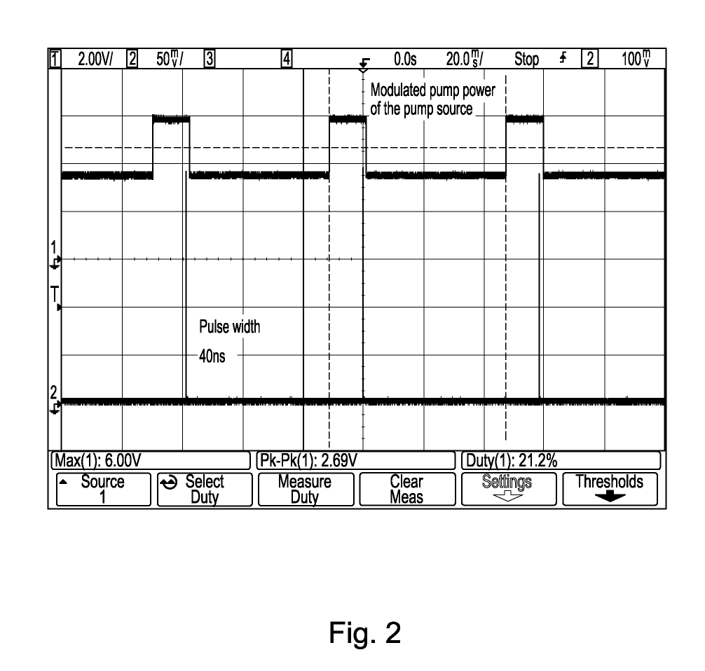

FIG. 2 shows the output measurement of the all-fiber saturable absorber Q-switched laser 10 according to the preferred embodiment above. The pulse energy and the pulse width of the output laser pulse shown in FIG. 2 are 2.4 μJ and 40 ns. Moreover, for the ring resonator having a roundtrip length of 100 cm, the pulse width of the output laser pulse can be narrowed down to 10 ns and the peak pulse power of the all-fiber saturable absorber Q-switched laser 10 is about 240 W.

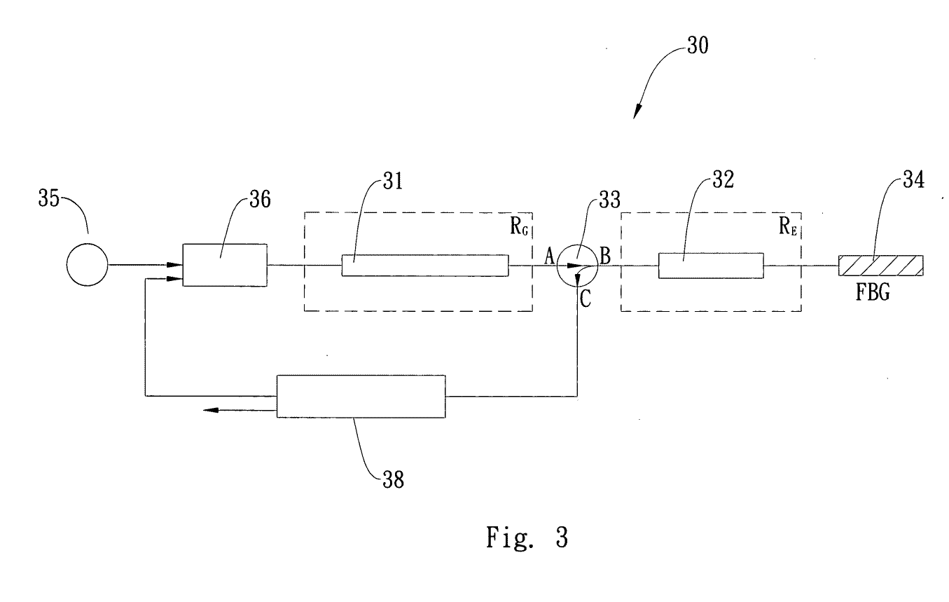

Referring now to FIG. 3, it is a schematic diagram of an all-fiber saturable absorber Q-switched laser according to a second embodiment of the present invention. According to this embodiment, the all-fiber saturable absorber Q-switched laser 30 with a ring resonator comprises a gain fiber 31, a saturable absorber fiber 32, an optical circulator 33, a fiber grating 34; a wavelength division multiplexer 36 configured at the output side of a pump source35, a power splitter 38, and other optical components. The ring resonator is formed by the gain fiber 31, the optical circulator 33, and the fiber grating 34. The difference between this embodiment and the first embodiment is that the laser beam is 100% reflected back to the ring resonator by the fiber grating 34.

The power splitter 38 is configured at a second output side (port C) of the optical circulator 33 to output a certain part of laser beam from the resonator. As discussed above, after the saturable absorber fiber 32 is saturated, the laser beam from the optical circulator 33 is not absorbed by the saturable absorber fiber 32. Then the output part of the laser beam is Q-switched, thereby giving rise to a high-intensity Q-switched laser pulse. The laser beam passes intensity-enhanced section R_{E} twice in one roundtrip of the all-fiber saturable absorber Q-switched laser 30. The photon density in the saturable absorber fiber 32 is therefore on average twice (or more than twice) that in the gain fiber 31. The higher photon intensity results in a fast bleaching of the saturable absorber fiber 32, and then a passive Q-switching performance.

It is apparent from the discussion above that by the present invention, the structure of a passive Q-switched laser is simplified, the efficiency of the saturable absorber Q-switching is increased, and the choice of Q-switch materials is more flexible. Moreover, since the present invention is an all-fiber design which has low cavity loss, high Q-switching efficiency, ease of packaging and operation, and low fabrication cost.

What is claimed is:

1. An all-fiber saturable absorber Q-switched laser comprising:
a gain fiber pumped by a pump source and emitting a laser beam;
an optical circulator configured at an output side of the gain fiber to exclude a light beam emitted by the pump source and to output the laser beam;
a fiber grating configured at a first output side of the optical circulator, the fiber grating and the optical circulator defining an intensity-enhanced section; and
a saturable absorber fiber configured in the intensity-enhanced section to absorb the laser beam and to produce a laser pulse when the saturable absorber is saturated.

2. The all-fiber saturable absorber Q-switched laser of claim. 1, wherein the gain fiber, the optical circulator and the fiber grating form a ring resonator.

3. The all-fiber saturable absorber Q-switched laser of claim 2, wherein the fiber grating is configured to reflect a part of the laser beam back to the ring resonator, and output a remaining part of the laser beam which is not reflected thereby.

4. The all-fiber saturable absorber Q-switched laser of claim 2, further comprising a power splitter configured at a second output side of the optical circulator to output a certain part of laser beam from the ring resonator.

5. The all-fiber saturable absorber Q-switched laser of claim 2, wherein the optical circulator is configured to control the resonant direction of the ring resonator.

6. The all-fiber saturable absorber Q-switched laser of claim 1, wherein the wavelength of the saturable absorber Q-switched laser is determined by the reflection spectrum of the fiber grating.

7. The all-fiber saturable absorber Q-switched laser of claim 1, further comprising a wavelength division multiplexer configured at an input side of the gain fiber to couple the light beam emitted by the pump source into the gain fiber.

8. The all-fiber saturable absorber Q-switched laser of claim 1, wherein the gain fiber is an erbium-doped fiber.

9. The all-fiber saturable absorber Q-switched laser of claim 1, wherein the saturable absorber fiber is an erbium-doped fiber.

10. A method for producing a saturable absorber Q-switched laser pulse comprising:
pumping a gain fiber by a pump source to emit a laser beam;
guiding the laser beam to an optical circulator to control the resonant direction of the laser beam; and
absorbing the laser beam by a saturable absorber fiber and producing a laser pulse after the saturable absorber fiber is saturated.

11. The method for producing a saturable absorber Q-switched laser pulse of claim 10, further comprising: coupling the light beam emitted by the pump source into the gain fiber by a wavelength division multiplexer to pump the gain fiber and generate the laser beam.

12. The method for producing a saturable absorber Q-switched laser pulse of claim 10, further comprising: determining the wavelength of the saturable absorber Q-switched laser and reflecting a part of the laser beam back to the ring resonator.

13. The method for producing a saturable absorber Q-switched laser pulse of claim 10, further comprising: outputting a certain part of the laser beam from the ring resonator.

14. The method for producing a saturable absorber Q-switched laser pulse of claim 10, wherein the saturable absorber fiber absorbs the laser beam until the saturable absorber fiber is saturated.
